(19) United States
(12) Patent Application Publication
(10) Pub. No.: US 2021/0261142 A1
(43) Pub. Date: Aug. 26, 2021

(54) INFORMATION PROCESSING APPARATUS

(71) Applicant: DENSO CORPORATION, Kariya-city (JP)

(72) Inventors: Yukiyasu YOSHIMURA, Kariya-city (JP); Megumi ANAMI, Kariya-city (JP)

(21) Appl. No.: 17/319,539

(22) Filed: May 13, 2021

Related U.S. Application Data
(63) Continuation of application No. PCT/JP2019/045996, filed on Nov. 25, 2019.

(30) Foreign Application Priority Data
Dec. 7, 2018 (JP) 2018-229789

(51) Int. Cl. B60W 40/09; B60W 40/10; G06K 9/00

(52) U.S. Cl. CPC B60W 40/09; B60W 40/10; B60W 2400/00; B60W 2540/22; G06K 9/00275

(57) ABSTRACT

In an Information processing apparatus mounted on a vehicle, service specifying information, and satisfaction level information are acquired and transmitted to a server outside the vehicle. The service specifying information specifies a service provided to an occupant in the vehicle through a device mounted on the vehicle or through a portable device held by the occupant in the vehicle. The satisfaction level information is capable of specifying a satisfaction level of the occupant with respect to the service.

### CROSS REFERENCE TO RELATED APPLICATIONS

The present application is a continuation application of International Patent Application No. PCT/JP2019/045996 filed on Nov. 25, 2019, which designated the U.S. and claims the benefit of priority from Japanese Patent Application No. 2018-229789 filed to the Japan Patent Office on Dec. 7, 2018. The entire disclosures of all of the above applications are incorporated herein by reference.

### TECHNICAL FIELD

The present disclosure relates to an information processing apparatus.

### BACKGROUND

It is important for a business operator who sells a product or provides a service to know the reaction of a customer to the product or service in order to improve the quality of the product or service provided by the business operator.

### SUMMARY

According to an example of the present disclosure, an information processing apparatus is provided to be mounted on a vehicle. In the Information processing apparatus mounted on a vehicle, service specifying information, and satisfaction level information are acquired and transmitted to a server outside the vehicle. The service specifying information specifies a service provided to an occupant in the vehicle through a device mounted on the vehicle or through a portable device held by the occupant in the vehicle. The satisfaction level information is capable of specifying a satisfaction level of the occupant with respect to the service.

### BRIEF DESCRIPTION OF DRAWINGS

The objects, features, and advantages of the present disclosure will become more apparent from the following detailed description made with reference to the accompanying drawings. In the drawings:

FIG. 1 is a block diagram showing an outline of a configuration of a satisfaction level feedback system;

FIG. 2 is a block diagram showing details of the configuration of a satisfaction level feedback system according to a first embodiment;

FIG. 3 is a flowchart showing a satisfaction level information transmission process according to the first embodiment;

FIG. 4 is a flowchart showing an awakening state determination process;

FIG. 5 is examples of information transmitted by the information processing apparatus according to the first embodiment;

FIG. 6 is a flowchart showing a driving behavior information transmission process;

FIG. 7 is a block diagram showing details of the configuration of a satisfaction level feedback system according to a second embodiment;

FIG. 8 is a flowchart showing a satisfaction level information transmission process according to the second embodiment; and

FIG. 9 is examples of information transmitted by the information processing apparatus according to the second embodiment.

### DETAILED DESCRIPTION

Embodiments of the present disclosure will be described with reference to the drawings.

### 1. First Embodiment

[1-1. Configuration]

[1-1-1. Overview of Satisfaction Level Feedback System]

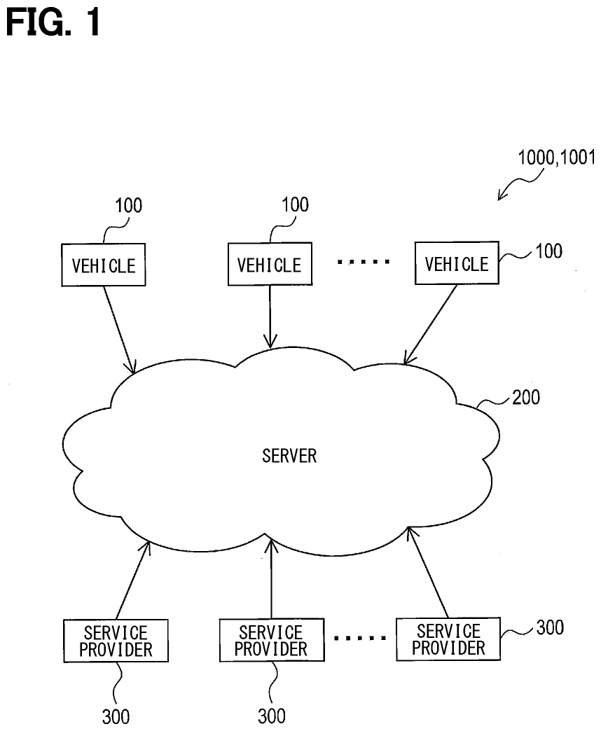

An information processing apparatus 10 of the present disclosure is mounted on a vehicle 100 in a satisfaction level feedback system 1000 shown in FIG. 1. The satisfaction level feedback system 1000 includes a plurality of vehicles 100 and a server 200 outside the vehicle 100. In this embodiment, the server 200 is a cloud server.

The vehicle 100 transmits, to the server 200, (i) service specifying information that specifies the service provided to an occupant in the vehicle 100 and (ii) satisfaction level information that can specify the satisfaction level of the occupant with respect to the service, through the information processing apparatus 10 described in detail later.

The service in the present disclosure is provided through a device mounted on the vehicle 100 or through a portable device held by the occupant in the vehicle 100. In addition, the service is provided to the occupant in the moving vehicle 100, particularly the driver.

An example of a service is a service that can affect the driving of the vehicle 100 by the driver, in other words, a service provided to change the driving of the vehicle 100 by the driver. Specific examples thereof include services that can affect the driving behavior of the vehicle 100 by the driver, the destination of the vehicle 100, and the like. The driving behavior includes a running state of the vehicle 100 driven by the driver and a driving operation of the vehicle 100 by the driver.

Examples of services that can affect the driving behavior of the vehicle 100 by the driver include (i) a service that encourages the driver to awaken by giving aroma, vibration, wind, etc. to the driver who is feeling drowsy, and (ii) a driving advice to the driver. In addition, as a service that can affect the destination of the vehicle 100, there is a service that uses GPS information to deliver advertisements for parking lots, facilities, etc. in the vicinity where the vehicle 100 travels.

In addition to these, the services include all services provided through the device mounted on the vehicle 100 or through the portable device held by the occupant in the vehicle 100, such as a service for randomly playing music in the vehicle 100.

The service specifying information refers to a service ID assigned to each service. The number of services provided in the vehicle 100 is not limited to one, and may be multiple. For example, there are cases where a plurality of services are provided by a plurality of service providers 300, cases where a plurality of services are provided by the same service provider 300, and combinations thereof. With the service ID assigned to each service in advance, it is possible to specify a service and a service provider 300 among a plurality of services provided in the vehicle 100.

The information processing apparatus 10 in the vehicle 100 transmits, to the server 200, the service ID and the satisfaction level information in association with each other; the satisfaction level information can specify the satisfaction level of the occupant who has received the service of the service ID. The satisfaction level information will be described in detail later.

A plurality of the information transmitted from a plurality of vehicles 100 are stored in a database 202 in the server 200. Each service provider 300 can access the database 202 in the server 200 by itself and extract the satisfaction level information for the service provided by itself from the database 202 in the server 200 by using the service ID. The service provider 300 can utilize the acquired information for improving the service provided by itself.

[1-1-2. Configuration of Satisfaction Level Feedback System]

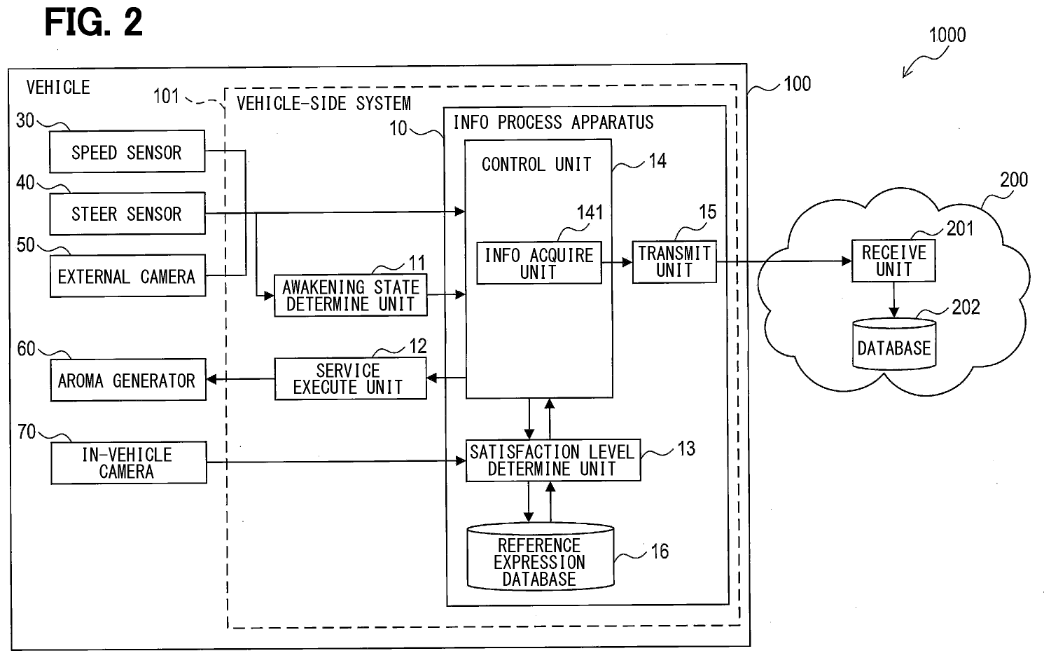

Hereinafter, the satisfaction level feedback system 1000 of the first embodiment will be described in more detail with reference to FIG. 2. The first embodiment assumes that the service is a service that activates an aroma generator to urge the driver to awaken when the service detects that the driver feels drowsy. Hereinafter, the service provided to the driver in the first embodiment is also referred to as an awakening service.

The vehicle 100 includes a vehicle-side system 101 of the satisfaction level feedback system 1000. Further, the vehicle 100 includes a vehicle speed sensor 30, a steering sensor 40, a vehicle external camera 50, an aroma generator 60, and an in-vehicle camera 70 as in-vehicle devices.

The vehicle speed sensor 300 detects the current traveling speed of the vehicle 100.

The steering sensor 40 detects the steering angle of the vehicle 100 by operating the steering wheel.

The vehicle exterior camera 50 is configured to photograph or capture an image in front of the vehicle 100, that is, the traveling direction of the vehicle 100. From the image taken by the vehicle external camera 50, the road shape on which the vehicle 100 travels is extracted by image processing.

The aroma generator 60, which generates the aroma, is mounted in a front area in the interior of the vehicle 100, at least at a position where the aroma reaches the driver.

The in-vehicle camera 70 is provided in a front area in the interior of the vehicle 100 at a position facing the driver, for example, an A pillar, a meter panel, or the like, and takes a picture of the driver seated in the driver's seat from the front of the vehicle.

The vehicle-side system 101 mainly includes a microcomputer including a CPU, RAM, ROM, I/O, a bus line connecting these components, and the like, and executes various processes. The vehicle-side system 101 incudes functional blocks realized by the CPU executing a program stored in the ROM, that is, as virtual components, which are an awakening state determination unit 11, a service execution unit 12, and a satisfaction level determination unit 13, a control unit 14, and a transmission unit 15. Further, the vehicle-side system 101 includes a reference facial expression database 16 as a component for storing reference facial expression data described later.

The awakening state determination unit 11 is configured to determine whether or not the driver is in the awakening state based on the information acquired from the vehicle speed sensor 30, the steering sensor 40, and the vehicle external camera 50. Further, when determining that the driver is not in the awake state, the awakening state determination unit 11 is configured to notify the control unit 14 of that effect. The specific process of determining the awakening state performed by the awakening state determination unit 11 will be described in detail later.

The service execution unit 12 is configured to control the operation of the aroma generator 60. In particular, the service execution unit 12 is configured to operate the aroma generator 60 when there is a request from the control unit 14, which will be described later, to start providing the awakening service.

The satisfaction level determination unit 13 is configured to determine the driver's satisfaction level in response to a request from the control unit 14, which will be described later. Specifically, the satisfaction level determination unit 13 compares the facial expression of the driver extracted from the image of the driver acquired by the in-vehicle camera 70 with the reference facial expression data which is the data of the driver's normal facial expression. By doing so, the degree of emotions such as joy, anger, and confusion of the driver who received the awakening service is estimated. The reference facial expression data is stored in the reference facial expression database 16. The satisfaction level determination unit 13 determines the driver's satisfaction level with the awakening service based on the obtained emotional degree. Further, the satisfaction level determination unit 13 is configured to output the determined satisfaction level to the control unit 14 as satisfaction level information of the driver who has received the awakening service.

As described above, the control unit 14 is configured to request the service execution unit 12 to start providing the awakening service. Further, the control unit 14 is configured to request the satisfaction level determination unit 13 to determine the satisfaction level.

Further, the control unit 14 includes an information acquisition unit 141 configured to acquire information to be transmitted to the server 200. In addition to the above-mentioned service specifying information of the awakening service and the above-mentioned satisfaction level information, the information acquisition unit 141 acquires the followings: (i) environment specifying information that can identify the driving environment of the vehicle 100 when the awakening service is provided, (ii) time information on time when the awakening service is provided, and (iv) driving behavior information that can identify the driving behavior of the vehicle 100 by the driver after the awakening service is provided to the driver.

The information acquisition unit 141 acquires the service ID corresponding to the awakening service provided this time from the service ID information stored in the ROM in advance as the service specifying information. Further, the control unit 14 acquires the satisfaction level determined by the satisfaction level determination unit 13 as the satisfaction level information.

The environment specifying information acquired by the information acquisition unit 141 is information that can specify the driving environment of the vehicle 100. The driving environment refers to at least one of the environment surrounding the vehicle 100 and the environment surrounding the driver who drives the vehicle 100. The driving environment information may include information on any state that can be detected by the detection device mounted on the vehicle 100. Examples of the environment surrounding the vehicle 100 include a running state of the vehicle 100, a driving operation for the vehicle 100, and an environment around the vehicle 100. Specific examples of the driving environment information regarding the environment surrounding the vehicle 100 include vehicle speed, steering angle, accelerator depression amount, brake depression amount, blinker operation state, road shape, and the like. Further, an environment surrounding the driver who drives the vehicle 100 may include the spatial environment inside the vehicle 100. Specific examples of the driving environment information regarding the environment surrounding the driver may include the room temperature inside the vehicle 100. The information acquisition unit 141 acquires at least one of a plurality of the information above as environment specifying information. In the present embodiment, the information acquisition unit 141 acquires the vehicle speed, the steering angle, and the road shape as environment specifying information. The information acquisition unit 141 acquires the vehicle speed from the vehicle speed sensor 30, the steering angle from the steering sensor 40, and the road shape from the vehicle external camera 50.

Further, the driving behavior information acquired by the information acquisition unit 141 is information that can specify the driving behavior of the vehicle 100 by the driver of the vehicle 100. Examples of the driving behavior include a running state of the vehicle 100 driven by the driver, a driving operation of the vehicle 100 by the driver, and the like. The information acquisition unit 141 acquires at least one of a plurality of the above information as driving behavior information. Specific examples of the driving behavior information include vehicle speed, steering angle, accelerator depression amount, brake depression amount, and blinker operation state. In the present embodiment, the information acquisition unit 141 acquires the vehicle speed, the steering angle, and the road shape as driving behavior information.

The information acquisition unit 141 is configured to collectively output the service specifying information, the satisfaction level information, the environment specifying information, and the time information at the time of providing the awakening service, to the transmission unit 15. Further, the information acquisition unit 141 is configured to separately acquire the driving behavior information after the awakening service is provided to the driver and output it to the transmission unit 15. Hereinafter, the process of transmitting the former information is referred to as a satisfaction level information transmission process, and the process of transmitting the latter information is referred to as a driving behavior information transmission process.

The transmission unit 15 is configured to be able to communicate with the server 200 via a communication device (not shown). The transmission unit 15 transmits the information acquired from the information acquisition unit 141, to the server 200. Note that the communication device may be a wireless transceiver capable of communicating data with the server 200 via a wireless communication link.

The server 200 includes a receiving unit 201 and a database 202. The receiving unit 201 stores the information acquired from the vehicle 100 in the database 202.

In the present embodiment, the information processing apparatus 10 includes a satisfaction level determination unit 13, a control unit 14, a transmission unit 15, and a reference facial expression database 16, as functions.

[1-2. Process]

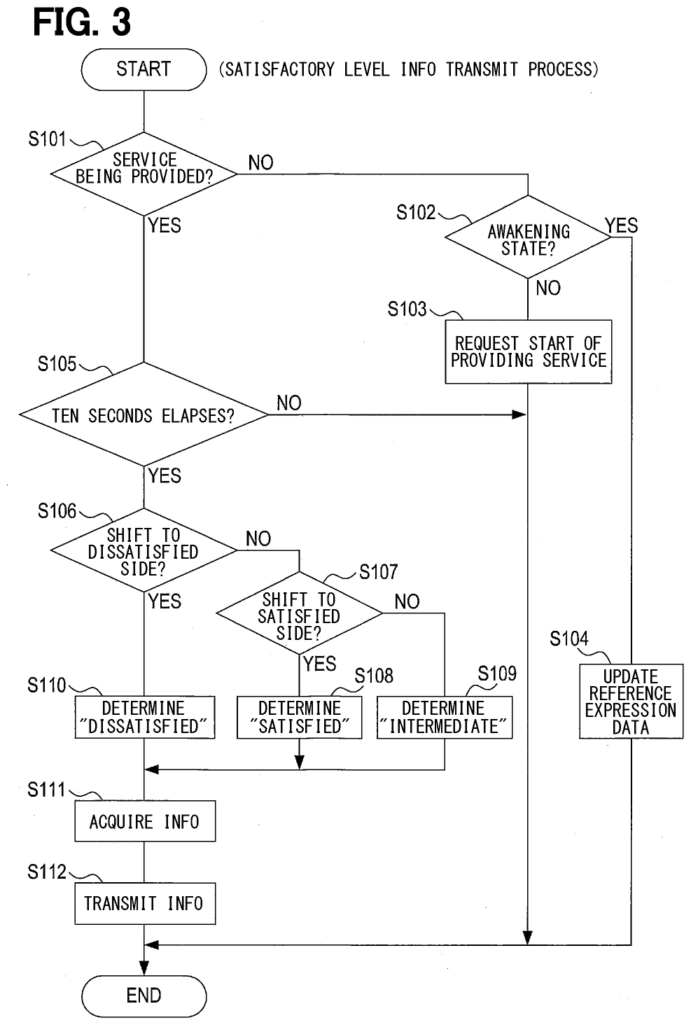

The satisfaction level information transmission process executed by the information processing apparatus 10 will be described with reference to the flowchart of FIG. 3. The satisfaction level information transmission process shown in FIG. 3 is repeatedly executed at a predetermined cycle after the ignition switch of the vehicle 100 is turned on.

First, in S101, the information processing apparatus 10 determines whether or not the awakening service is being provided.

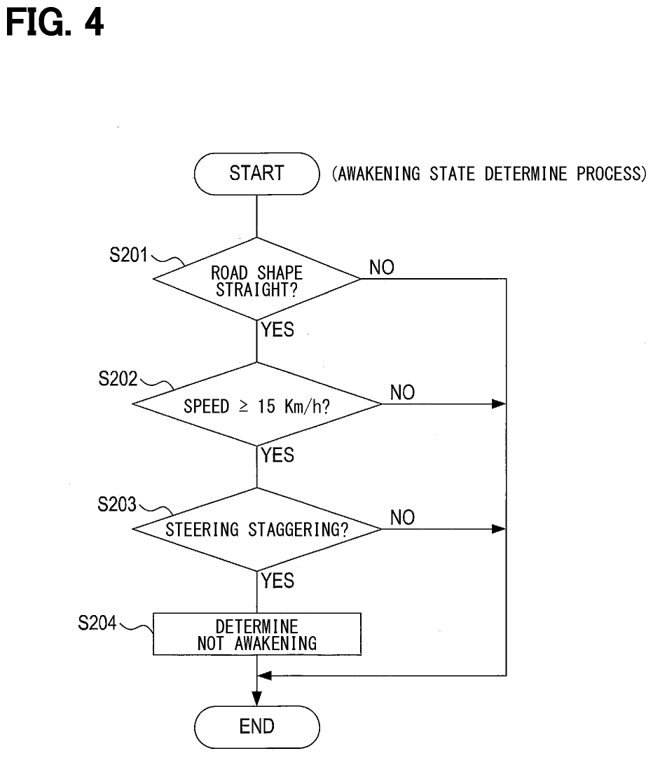

When the information processing apparatus 10 determines in S101 that the awakening service is not being provided, the information processing apparatus 10 proceeds to S102 and determines whether or not the driver is in the awakening state. Specifically, the information processing apparatus 10 determines in S102 whether or not the driver is in the awakening state based on the result of the awakening state determination process shown in FIG. 4 performed by the awakening state determination unit 11. On the other hand, when the information processing apparatus 10 determines in S101 that the awakening service is being provided, the information processing apparatus 10 proceeds to S105 and determines whether or not ten seconds have elapsed for the first time since the start of providing the awakening service.

The awakening state determination process shown in FIG. 4 is repeatedly executed at a predetermined cycle after the ignition switch of the vehicle 100 is turned on. The awakening state determination process shown in FIG. 4 corresponds to the processing as an awakening state determination unit 11.

First, in S201, the awakening state determination unit 11 determines whether or not the road shape is straight.

When the awakening state determination unit 11 determines in S201 that the road shape is straight, it proceeds to S202 and determines whether or not the vehicle speed is 15 km/h or more.

On the other hand, when the awakening state determination unit 11 determines in S201 that the road shape is not a straight, the awakening state determination process of FIG. 4 ends.

When the awakening state determination unit 11 determines in S202 that the vehicle speed is 15 km/h or more, the awakening state determination unit 11 proceeds to S203 and determines whether or not the steering operation is staggering.

On the other hand, when the awakening state determination unit 11 determines in S202 that the vehicle speed is not 15 km/h or more, the awakening state determination process of FIG. 4 ends.

When the awakening state determination unit 11 determines in S203 that the steering operation is staggering, the awakening state determination unit 11 proceeds to S204. After determining that the driver is not in the awakening state and notifying the information processing apparatus 10 of that effect, the awakening state determination process of FIG. 4 is ended.

On the other hand, when the awakening state determination unit 11 determines in S203 that the steering operation is not staggering, the awakening state determination process of FIG. 4 ends.

Returning to the description of the satisfaction level information transmission process of FIG. 3.

When the information processing apparatus 10 determines in S102 that the driver is not in the awakening state, the information processing apparatus 10 proceeds to S103, requests the service execution unit 12 to start providing the awakening service. The satisfaction level information transmission process of FIG. 3 is then ended. On the other hand, when the information processing apparatus 10 determines in S102 that the driver is in the awakening state, the information processing apparatus 10 updates the reference facial expression data stored in the reference facial expression database 16 based on the facial expression data acquired this time in S104. The satisfaction level information transmission process of FIG. 3 is then ended.

When the information processing apparatus 10 determines in S105 that ten seconds have elapsed for the first time since the start of providing the awakening service, the information processing apparatus 10 proceeds to S106. In S106, the information processing apparatus 10 determines whether or not the driver's facial expression for the last ten seconds has shifted to the dissatisfied side by comparing with the reference facial expression data stored in the reference facial expression database 16. Specifically, as described above, the information processing apparatus 10 estimates the degree of emotion of the driver by comparing the facial expression of the driver with the reference facial expression data. The satisfaction level of the driver is thereby determined based on the degree of the emotion.

On the other hand, when the information processing apparatus 10 determines in S105 that ten seconds have not elapsed for the first time since the start of providing the awakening service, the information processing apparatus 10 ends the satisfaction level information transmission process of FIG. 3.

When the information processing apparatus 10 determines in S106 that the driver's facial expression for the last ten seconds has not shifted to the dissatisfied side, the information processing apparatus 10 proceeds to S107. It is determined whether or not the driver's facial expression for the last ten seconds has shifted to the satisfied side by comparing with the reference facial expression data.

On the other hand, when the information processing apparatus 10 determines in S106 that the driver's facial expression for the last 10 seconds has shifted to the dissatisfied side, the information processing apparatus 10 proceeds to S110. The driver's satisfaction level is then determined to be as “dissatisfied”.

When the information processing apparatus 10 determines in S107 that the driver's facial expression for the last ten seconds has shifted to the satisfied side, the information processing apparatus 10 proceeds to S108. After determining the driver's satisfaction level as “satisfied”, the information processing apparatus 10 proceeds to S111.

On the other hand, when the information processing apparatus 10 determines in S107 that the facial expression of the driver for the last ten seconds has not shifted to the satisfied side, the information processing apparatus 10 proceeds to S109. After determining the driver's satisfaction level as “intermediate”, the information processing apparatus 10 proceeds to S111. In addition, S106 to S110 correspond to the processing as a satisfaction level determination unit 13.

Subsequently, in S111, the information processing apparatus 10 acquires the above-mentioned service ID, the vehicle speed, the degree of steering, and the road shape when the awakening service is provided, and the time information when the awakening service is provided. Note that S111 corresponds to the processing as an information acquisition unit 141.

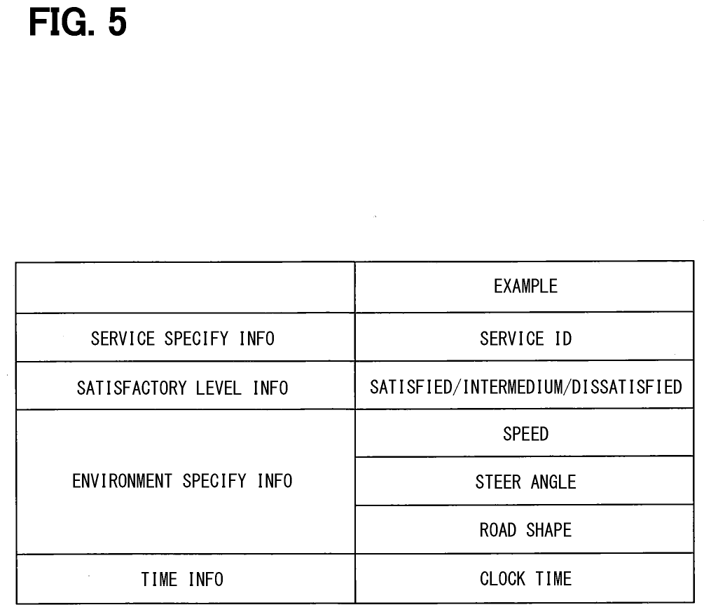

Subsequently, in S112, the information processing apparatus 10 transmits, to the server 200, the data shown in FIG. 5, which is a collection of the information acquired in S111 and the determined satisfaction level, via a communication device (not shown) mounted on the vehicle 100. After that, the satisfaction level information transmission process of FIG. 3 is ended. Note that S112 corresponds to the processing as a transmission unit 15.

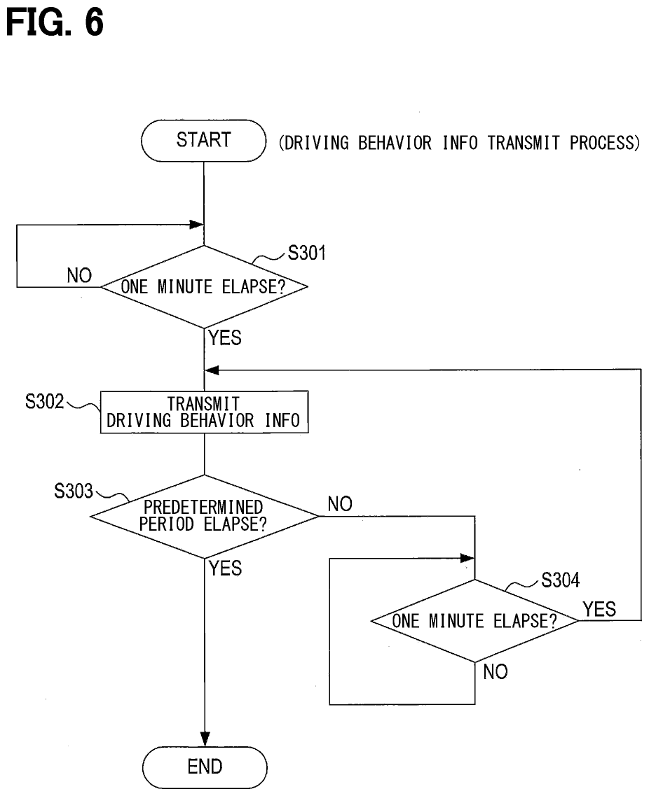

Next, the driving behavior information transmission process executed by the information processing apparatus 10 will be described with reference to the flowchart of FIG. 6. The driving behavior information transmission process shown in FIG. 6 is executed when the provision of the awakening service is started.

First, in S301, the information processing apparatus 10 determines whether or not one minute has elapsed from the start of providing the awakening service.

When the information processing apparatus 10 determines in S301 that one minute has not elapsed since the start of providing the awakening service, the information processing apparatus 10 returns to S301.

On the other hand, when it is determined in S301 that one minute has elapsed since the start of providing the awakening service, the information processing apparatus 10 proceeds to S302. The vehicle speed, steering angle, and road shape at the present time are acquired, and all of the acquired information or data is transmitted as driving behavior information.

Subsequently, in S303, the information processing apparatus 10 determines whether or not a predetermined period has elapsed since the start of providing the awakening service.

When the information processing apparatus 10 determines in S303 that a predetermined period has not elapsed since the start of providing the awakening service, the information processing apparatus 10 proceeds to S304. It is determined whether or not one minute has elapsed since the driving behavior information was transmitted.

When the information processing apparatus 10 determines that one minute has elapsed since the driving behavior information was transmitted in S304, the information processing apparatus 10 returns to S302.

On the other hand, when the information processing apparatus 10 determines that one minute has not elapsed since the driving behavior information was transmitted in S304, the information processing apparatus 10 returns to S304.

On the other hand, when the information processing apparatus 10 determines in S303 that the predetermined period has elapsed, the information processing apparatus 10 ends the driving behavior information transmission process of FIG. 6.

[1-3. Effects]

According to the first embodiment described above, the following effects are obtained.

(1a) The information processing apparatus 10 acquires satisfaction level information that can specify the satisfaction level of the occupant with respect to the service (S106 to S110), and transmits the satisfaction level information to the server 200 (S112). With such a configuration, the service provider 300 can obtain the occupant's satisfaction level with the service provided to the occupant through the server 200.

(1b) The information processing apparatus 10 acquires the service specifying information that specifies the service provided to the occupant (S111), and transmits the service specifying information to the server 200 (S112). According to such a configuration, it is possible to specify the satisfaction level information corresponding to a specific service from the satisfaction level information corresponding to a plurality of services that can be provided in the vehicle 100. That is, the service provider 300 can specify the satisfaction level information corresponding to (i) a service provided by oneself or (ii) a specific service among a plurality of services provided by oneself, from the satisfaction level information corresponding to multiple services based on the service specifying information.

(1c) The information processing apparatus 10 acquires environment specifying information that can specify the driving environment of the vehicle 100 at the time of providing the service (S111), and transmits the environment specifying information to the server 200 (S112). With such a configuration, the service provider 300 can know in what kind of driving environment the service is provided. In particular, when the service provided target person is the driver of the vehicle 100, what kind of driving operation the driver was performing at the time of providing the service and under what environment the driver was performing the driving operation based on the above environment specifying information.

(1d) The information processing apparatus 10 separately acquires driving behavior information capable of specifying the driving behavior of the vehicle 100 by the driver of the vehicle 100 after the service is provided to the occupant. The driving behavior information is then transmitted to the server 200 (S303). According to such a configuration, the service provider 300 can know how the service provided by the service provider 300 that can affect the driving behavior actually affects the driving behavior.

(1e) In particular, in the above embodiment, information on the vehicle speed, steering angle, and road shape, which can determine the awakening state of the driver, is transmitted as driving behavior information. Therefore, it is possible to grasp how the awakening state of the driver has changed after the awakening service is provided. In addition, by analyzing together with the satisfaction level information for the awakening service, it is possible to perform advanced data analysis such that the awakening effect is small even if the satisfaction level for a specific aroma is high.

(1f) The satisfaction level information is determined based on the facial expressions of the occupant in the vehicle 100. Therefore, in order for the service provider 300 to obtain satisfaction level with the service, the occupant is not required to take action to answer the satisfaction level. For example, it is not necessary to take an action such as pressing a button to answer a questionnaire about satisfaction level displayed on a display mounted on the vehicle 100. In particular, when the service provided target person is the driver of the vehicle 100, it is not preferable to have the driver take such an action because the driver should concentrate on driving while driving the vehicle 100. According to the above embodiment, since the satisfaction level information is automatically determined based on the facial expression of the driver, the satisfaction level for the service can be obtained without disturbing the driver's driving.

### 2. Second Embodiment

[2-1. Configuration]

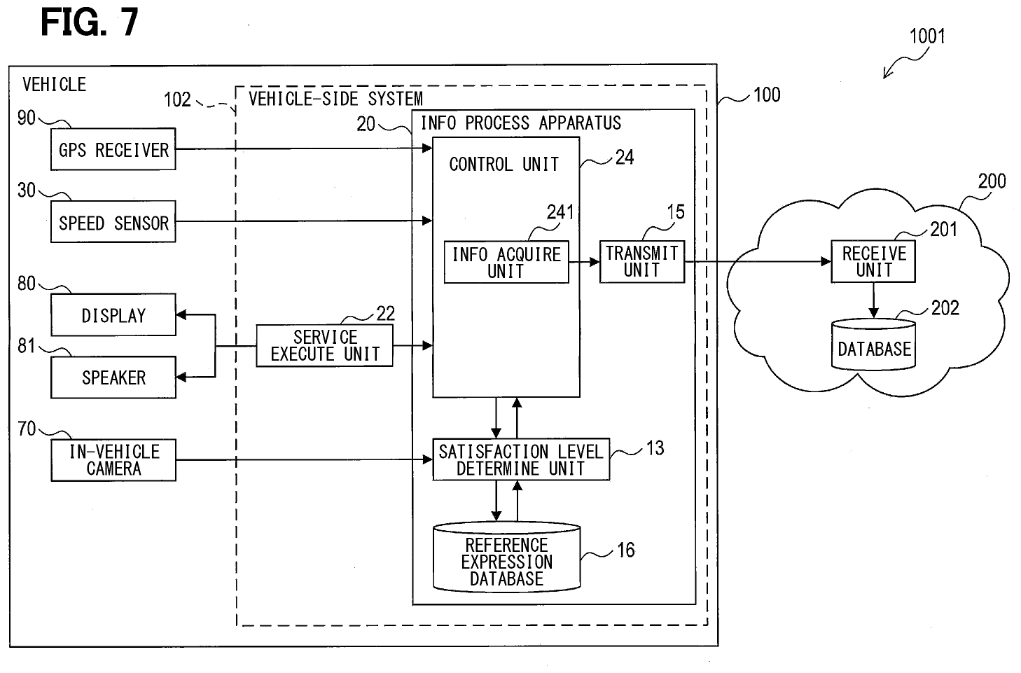

Hereinafter, the satisfaction level feedback system 1001 according to a second embodiment will be described with reference to FIG. 7. The second embodiment assumes that the service is a service that presents a parking lot with a coupon to the driver as an advertisement. Hereinafter, the service provided to the driver in the second embodiment is also referred to as an advertising service. Since basic configuration of the second embodiment is the same as that of the first embodiment, the description of the common configuration will not be made, and the description will be made on the differences.

The vehicle 100 includes a vehicle-side system 102 of the satisfaction level feedback system 1001. Further, the vehicle 100 includes a vehicle speed sensor 30, an in-vehicle camera 70, a display 80, a speaker 81, and a GPS receiver 90, as in-vehicle devices.

The vehicle speed sensor 81 detects the current traveling speed of the vehicle. The in-vehicle camera 70 is provided in a front area in the interior of the vehicle 100 at a position facing the driver, and photographs the driver in a state of being seated in the driver's seat from the front.

The display 80 displays an advertisement for a parking lot based on an instruction from the service execution unit 22, which will be described later. Further, the speaker 81 announces an advertisement for the parking lot based on the instruction of the service execution unit 22.

The GPS receiver 90 receives radio waves transmitted from artificial satellites for GPS via a GPS antenna (not shown) and detects the position information of the vehicle 100.

The vehicle-side system 102 mainly includes a microcomputer including a CPU, RAM, ROM, I/O, a bus line connecting these components, and the like, and executes various processes. The vehicle-side system 102 includes a service execution unit 22, a satisfaction level determination unit 13, a control unit 24, and a transmission unit 15, as functional blocks realized by the CPU executing a program stored in the ROM, that is, as virtual components. Further, the vehicle side system 102 includes a reference facial expression database 16 as a component for storing reference facial expression data.

The service execution unit 22 is configured to control the execution of the advertising service. Specifically, the service execution unit 22 is configured to execute the advertising service when it receives the advertisement data from a receiver (not shown). Specifically, the service execution unit 22 presents an advertisement using the display 80 and the speaker 81. Further, when the advertising service is executed, the service execution unit 22 is configured to notify the control unit 24 of that effect.

The satisfaction level determination unit 13 is configured to determine the driver's satisfaction level in response to a request from the control unit 24, which will be described later, as in the first embodiment. Further, the satisfaction level determination unit 13 is configured to output the determined satisfaction level to the control unit 24 as satisfaction level information of the driver who has received the advertising service.

The control unit 24 is configured to request the satisfaction level determination unit 13 to determine the satisfaction level. Further, the control unit 24 includes an information acquisition unit 241 configured to acquire information to be transmitted to the server 200. In addition to the above-mentioned service specifying information of the advertising service and the above-mentioned satisfaction level information, the information acquisition unit 241 is configured to acquire environment specifying information at the time of providing the advertising service, time information at the time of providing the advertising service, and position information after the advertising service is provided to the driver. In the present embodiment, the information acquisition unit 241 acquires the vehicle speed from the vehicle speed sensor 30 as the environment specifying information. In addition, the information acquisition unit 241 acquires the position information of the vehicle 100 from the GPS receiver 90.

The information acquisition unit 241 is configured to collectively output the service specifying information, the satisfaction level information, the environment specifying information, and the time information at the time of providing the advertising service, to the transmission unit 15. Further, the information acquisition unit 241 is configured to separately acquire the position information and output it to the transmission unit 15. Hereinafter, the process of transmitting the former information is referred to as a satisfaction level information transmission process; the process of transmitting the latter information is referred to as a position information transmission process.

Also in this embodiment, the information processing apparatus 20 includes a satisfaction level determination unit 13, a control unit 24, a transmission unit 15, and a reference facial expression database 16, as functions.

[2-2. Process]

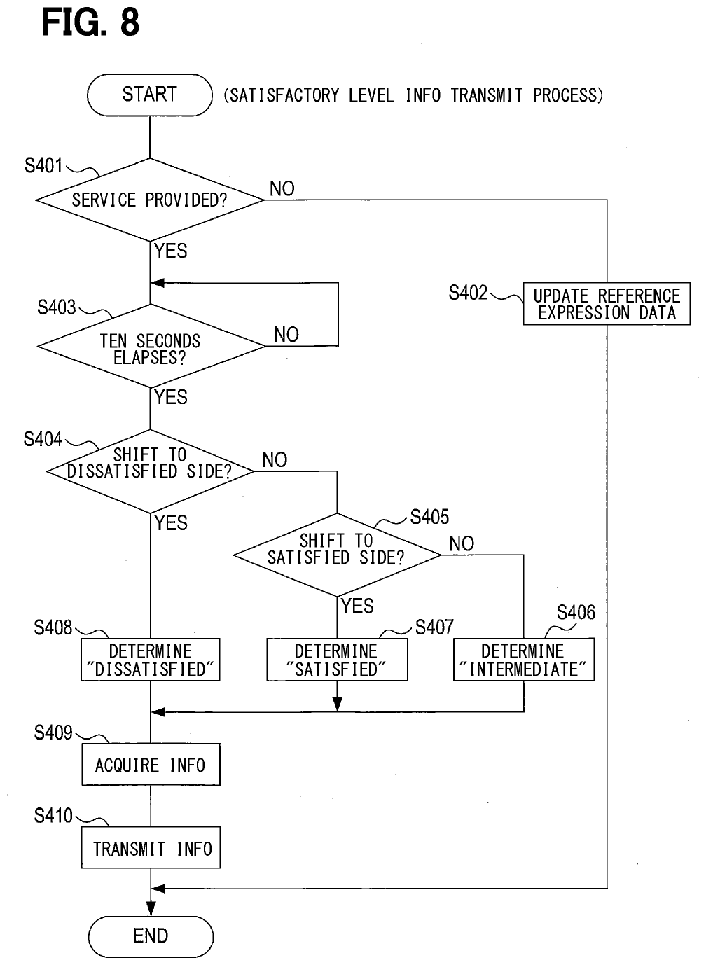

The satisfaction level information transmission process executed by the information processing apparatus 20 will be described with reference to the flowchart of FIG. 8. The satisfaction level information transmission process shown in FIG. 8 is repeatedly executed at a predetermined cycle after the ignition switch of the vehicle 100 is turned on.

First, in S401, the information processing apparatus 20 determines whether or not the advertising service has been provided. Specifically, after executing the previous satisfaction level information transmission process, the information processing apparatus 20 determines whether or not the advertising service has been provided based on whether or not the service execution unit 22 has notified that the advertising service has been executed.

When the information processing apparatus 20 determines that the advertising service has not been provided in S401, the information processing apparatus 20 proceeds to S402. After updating the reference facial expression data based on the facial expression data acquired this time in S402, the satisfaction level information transmission process of FIG. 8 is ended.

On the other hand, when the information processing apparatus 20 determines that the advertising service has been provided in S401, the information processing apparatus 20 proceeds to S403. It is determined whether or not ten seconds have elapsed since the advertising service was provided.

When the information processing apparatus 20 determines in S403 that ten seconds have not elapsed since the advertising service was provided, the information processing apparatus 20 returns to S403.

On the other hand, when the information processing apparatus 20 determines in S403 that ten seconds have elapsed since the advertising service was provided, the information processing apparatus 20 proceeds to S404. It is determined whether or not the driver's facial expression for the last ten seconds has shifted to the dissatisfied side by comparing with the reference facial expression data.

When the information processing apparatus 20 determines in S404 that the driver's facial expression for the last ten seconds has not shifted to the dissatisfied side, the information processing apparatus 20 proceeds to S405. It is determined whether or not the driver's facial expression for the last ten seconds has shifted to the satisfied side by comparing with the reference facial expression data.

On the other hand, when the information processing apparatus 20 determines in S404 that the driver's facial expression for the last ten seconds has shifted to the dissatisfied side, the information processing apparatus 20 proceeds to S408. The driver's satisfaction level is determined as “dissatisfied” in S408.

When the information processing apparatus 20 determines in S405 that the facial expression of the driver for the last ten seconds has not shifted to the satisfied side, the information processing apparatus 20 proceeds to S406. After determining the driver's satisfaction level as “intermediate” in S406, the information processing apparatus 20 proceeds to S409.

On the other hand, when the information processing apparatus 20 determines in S405 that the facial expression of the driver for the last ten seconds has shifted to the satisfied side, the information processing apparatus 20 proceeds to S407. After determining the driver's satisfaction level as “satisfied” in S407, the information processing apparatus 20 proceeds to S409. Note that S404 to S408 correspond to the processing as a satisfaction level determination unit 13.

Subsequently, in S409, the information processing apparatus 20 acquires the above-mentioned service ID, the vehicle speed at the time of providing the advertising service, and the time information at the time of providing the advertising service. Note that S409 corresponds to the processing as an information acquisition unit 241.

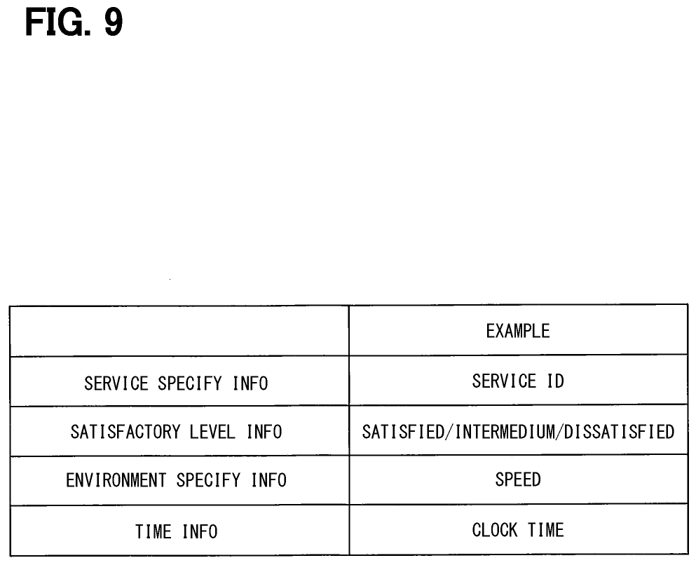

Subsequently, in S410, the information processing apparatus 20 transmits, to the server 200, the data shown in FIG. 9, which is a collection of the information acquired in S409 and the determined satisfaction level, via a communication device (not shown) mounted on the vehicle 100. After that, the satisfaction level information transmission process of FIG. 8 is ended. Note that S410 corresponds to the processing as a transmission unit 15.

The position information transmission process executed by the information processing apparatus 20 is the same as the driving behavior information transmission process in the first embodiment, except that the position information is transmitted instead of the driving behavior information in S302.

[2-3. Effects]

According to the second embodiment described in detail above, the following effects can be obtained in addition to the effects (1a) to (1d) and (1f) described in the first embodiment.

(2a) In the second embodiment, the information processing apparatus 20 separately acquires the position information of the vehicle 100 after the service is provided to the occupant, and transmits the position information to the server 200 (S303). With such a configuration, it is possible to know how the service, which is provided by the service provider 300 so as to affect the destination of the vehicle 100, actually affects the destination of the vehicle 100. Specifically, based on the position information transmitted from the information processing apparatus 20, it is possible to grasp whether or not the parking lot presented as an advertisement is actually used.

(2b) Further, in the second embodiment, the vehicle speed is transmitted as environment specifying information at the time of providing the service. Therefore, by analyzing the environment specifying information and the satisfaction level information for the advertising service, the advanced data analysis can be performed. For instance, if the advertisement is presented while the vehicle 100 is running, it is unpleasant; in contrast, if the advertisement is presented while the vehicle 100 is stopped, it is easy to accept.

### 3. Other Embodiments

While the embodiments of the present disclosure have been described above, the present disclosure is not limited to the above embodiments and can be variously modified.

(3a) In the above embodiments, the service is provided through the device mounted on the vehicle 100, specifically, the aroma generator 60, the display 80, or the speaker 81, but such a service providing device is not limited to this. For example, the service may be provided through a portable device held by an occupant in the vehicle 100, such as a smartphone. Specifically, the information processing apparatus 10 and 20 may be provided with a communication unit for communicating with the smartphone so that information on services provided by the smartphone to the occupant through an application or the like can be acquired from the smartphone via the communication unit. Then, the information processing apparatus 10 and 20 may transmit the acquired information to the server 200.

(3b) In the above embodiments, the satisfaction level of the driver is determined, but the determination target of the satisfaction level is not particularly limited as long as it is an occupant in the vehicle 100.

(3c) In the above embodiments, the information processing apparatus 10 and 20 transmits (i) the environment specifying information, (ii) the time information, and (iii) the driving behavior information or position information, in addition to the service specifying information and the satisfaction level information. The information transmitted by the processing apparatus 10 and 20 is not limited to these. For example, the information processing apparatus 10 and 20 may transmit information such as a gender and age of a provided target person of the service. According to such a configuration, it is possible to analyze the preference of each provided target person and analyze the preference based on an attribute group such as the gender of the provided target person. As the information of the service provided target person, information acquired from the in-vehicle camera 70, information registered in the vehicle, information grasped by the service provider 300 by user registration, and the like can be used. Further, in the above embodiments, either the driving behavior information or the position information is transmitted as the information to be transmitted after the service is provided, but both the driving behavior information and the position information may be transmitted.

(3d) Further, for example, the information processing apparatus 10 and 20 may transmit information regarding the content of the provided service in addition to the service specifying information and the satisfaction level information. Specifically, in the case of the awakening service of the first embodiment, the content of the service may include operating conditions such as the operating time of the aroma generator 60 and the type of aroma. In the case of the advertising service of the second embodiment, the content of the service may include the execution conditions of the advertising service such as the type of the provided advertisement and the time when the advertisement is presented. According to such a configuration, the service provider 300 can improve its own service based on the provided service content.

(3e) The service provided to the occupant of the vehicle 100 is not limited to the awakening service and the advertising service described in the above embodiments. For example, as an example of another service, there is a service that provides driving advice to the driver of the vehicle 100. In this case, by analyzing the satisfaction level information transmitted from the information processing apparatus and the environment specifying information at the time of providing the driving advice, it is possible to analyze the effect of the driving advice depending on the timing of providing the service. In addition, the information processing apparatus transmits information such as a running state of the vehicle 100 driven by the driver and a driving operation on the vehicle 100 by the driver, as driving behavior information. By doing so, it is possible to know what kind of change has occurred in driving behavior after receiving driving advice. In addition, the satisfaction level information for driving advice and the driving behavior information may be analyzed together. As a result, advanced data analysis can be performed, such as the degree of satisfaction level with driving advice is low, but driving behavior has improved.

(3f) In the above embodiments, the information processing apparatus 10 and 20 includes the satisfaction level determination unit 13, the control unit 14, and the transmission unit 15 as their functions, but the information processing apparatus 10 and 20 is not limited to include those functions. For example, the satisfaction level determination unit 13 may be realized on another hardware, and the information processing apparatus 10 and 20 may include an awakening state determination unit 11 and the like.

(3g) In the above embodiments, the satisfaction level determination unit 13 and the reference facial expression database 16 are provided on the vehicle 100, but the server 200 may include the satisfaction level determination unit 13 and the reference facial expression database 16. In this case, the information processing apparatus 10 and 20 transmit the driver's image or the like taken by the in-vehicle camera 70 to the server 200 as satisfaction level information.

(3h) A function of one configuration element in the embodiments described above may be implemented by multiple configuration elements. Functions of multiple configuration elements may be implemented by one configuration element. Moreover, the configuration of each embodiment may be in part omitted. At least a part of the configuration of each embodiment described above may be added to, replaced with another configuration of each embodiment described above, or the like.

(3i) The present disclosure may be implemented, in addition to the above-mentioned information processing apparatus 10 and 20, in various forms such as a system having the information processing apparatus 10 and 20 as a component, a program for operating a computer as the information processing apparatus 10 and 20, a storage medium on which the program is stored, and an information transmission method.

For reference to further explain features of the present disclosure, the description is added as follows.

It is important for a business operator who sells a product or provides a service to know the reaction of a customer to the product or service in order to improve the quality of the product or service provided by the business operator.

There is a method of calculating customer satisfaction level to a test-driving vehicle based on (i) physical information about the body of the driver when driving and (ii) vehicle behavior information regarding the behavior of the vehicle driven by the driver.

In recent years, various services have been provided to occupants in a vehicle through an in-vehicle device such as a car navigation device mounted on the vehicle and a portable device such as a smartphone. The detailed examination by the present inventors has found the following. That is, the service is provided to an occupant in a closed space such as in an interior of the vehicle; thus, it is usually difficult for a service provider to obtain occupant satisfaction level with the service provided by the service provider.

It is thus desired to provide an information processing apparatus that enables a service provider to appropriately acquire the satisfaction level of an occupant with respect to the service provided by the service provider.

An aspect of the present disclosure described herein is set forth in the following clauses.

According to an aspect of the present disclosure, an information processing apparatus mounted on a vehicle is provided to include an information acquisition unit and a transmission unit. The information acquisition unit is configured to acquire (i) service specifying information that specifies a service provided to an occupant in the vehicle through a device mounted on the vehicle or through a portable device held by the occupant in the vehicle, and (ii) satisfaction level information capable of specifying a satisfaction level of the occupant with respect to the service. The transmission unit is configured to transmit the service specifying information and the satisfaction level information acquired by the information acquisition unit to a server outside the vehicle.

With such a configuration, the service provider can appropriately acquire the satisfaction level of the occupant with the service provided by the service provider.

What is claimed is:

1. An Information processing apparatus mounted on a vehicle, comprising:
an information acquisition unit configured to acquire (i) service specifying information that specifies a service provided to an occupant in the vehicle through a device mounted on the vehicle or through a portable device held by the occupant in the vehicle, and (ii) satisfaction level information capable of specifying a satisfaction level of the occupant with respect to the service; and
a transmission unit configured to transmit the service specifying information and the satisfaction level information acquired by the information acquisition unit to a server outside the vehicle,
wherein:
the information acquisition unit is further configured to acquire environment specifying information capable of specifying a driving environment of the vehicle at a time when the service is provided; and
the transmission unit is further configured to transmit the environment specifying information to the server.

2. The Information processing apparatus according to claim 1, wherein:
the environment specifying information is at least one of a running state of the vehicle, a driving operation on the vehicle, and an environment around the vehicle.

3. The Information processing apparatus according to claim 1, wherein:
the occupant is a driver of the vehicle.

4. The Information processing apparatus according to claim 1, wherein:
the satisfaction level information is determined based on a facial expression of the occupant.

5. The Information processing apparatus according to claim 1, wherein:
the information acquisition unit is further configured to acquire driving behavior information capable of specifying a driving behavior of the vehicle by the driver of the vehicle after the service is provided to the occupant; and
the transmission unit is further configured to transmit the driving behavior information to the server.

6. The Information processing apparatus according to claim 5, wherein:
the driving behavior information is at least one of a running state of the vehicle and a driving operation on the vehicle.

7. The Information processing apparatus according to claim 1, wherein:
the information acquisition unit is further configured to acquire position information of the vehicle after the service is provided to the occupant; and
the transmission unit is further configured to transmit the position information to the server.

8. An Information processing apparatus mounted on a vehicle, comprising:
one or more processors configured to
acquire (i) service specifying information that specifies a service provided to an occupant in the vehicle through a device mounted on the vehicle or through a portable device held by the occupant in the vehicle, and (ii) satisfaction level information capable of specifying a satisfaction level of the occupant with respect to the service, and
transmit the service specifying information and the satisfaction level information to a server outside the vehicle,
wherein:
the one or more processors are further configured to
acquire environment specifying information capable of specifying a driving environment of the vehicle at a time when the service is provided, and
transmit the environment specifying information to the server.
